(19) United States
(12) Patent Application Publication
(10) Pub. No.: US 2006/0049139 A1
(43) Pub. Date: Mar. 9, 2006

(54) Method and system for etching a gate stack

(75) Inventors: Annie Xia, Lynnfield, MA (US); Hiromasa Mochiki, Kofu-City (JP); Arpan P. Mahorowala, Bronxville, NY (US)

Correspondence Address: PILLSBURY WINTHROP SHAW PITTMAN, LLP, P.O. BOX 10500, MCLEAN, VA, 22102, US

(73) Assignees: Tokyo Electron Limited, Tokyo (JP); International Business Machines Corporation, Armonk, NY (US)

(21) Appl. No.: 10/926,404

(22) Filed: Aug. 26, 2004

(51) Int. Cl. C23F 1/00; B44C 1/22

(52) U.S. Cl. 216/67; 216/41; 156/345.36; 156/345.38

(57) ABSTRACT

A method and system is described for etching a tunable etch resistant anti-reflective (TERA) coating. The TERA coating can be utilized, for example, as a hard mask, or as an anti-reflective coating for complementing a lithographic structure. The TERA coating can include a structural formula R:C:H:X, wherein R is selected from the group consisting of Si, Ge, B, Sn, Fe, Ti, and combinations thereof, and wherein X is not present or is selected from the group consisting of one or more of O, N, S, and F. During the formation of a structure in a film stack, a pattern is transferred to the TERA coating using dry plasma etching having a SF₆-based etch chemistry.

This application relates to, but does not rely for priority on, co-pending U.S. Patent Application No. 10/XXX,XXX, entitled “Method and System for Etching a Film Stack,” attorney docket no. 071469-0310969, filed on even date herewith, the contents of which are incorporated herein by reference.

### BACKGROUND OF THE INVENTION

1. Field of the Invention

The present invention relates to a method of etching a gate stack in the formation of semiconductor devices and, more particularly, to a method and system for etching a tunable etch resistant anti-reflective coating.

2. Description of Related Art

In material processing methodologies, pattern etching includes the application of a patterned mask of radiation-sensitive material, such as photoresist, to a thin film on an upper surface of a substrate, and transferring the mask pattern to the underlying thin film by etching. The patterning of the radiation-sensitive material generally involves coating an upper surface of the substrate with a thin film of radiation-sensitive material and then exposing the thin film of radiation-sensitive material to a radiation source through a reticle (and associated optics) using, for example, a photolithography system. Then, a developing process is performed, during which the removal of the irradiated regions of the radiation-sensitive material occurs (as in the case of positive photoresist), or the removal of non-irradiated regions occurs (as in the case of negative resist) using a base developing solution, or solvent. The remaining radiation-sensitive material exposes the underlying substrate surface in a pattern that is ready to be etched into the surface. Photolithographic systems for performing the above-described material processing methodologies have become a mainstay of semiconductor device patterning for the last three decades, and are expected to continue in that role down to 65 nm resolution, and less.

The resolution (rₒ) of a photolithographic system determines the minimum size of devices that can be made using the system. Having a given lithographic constant k₁, the resolution is given by the equation
rₒ=k₁λ/NA, (1)
where λ is the operational wavelength, and NA is the numerical aperture given by the equation
NA=n·sin θₒ. (2)
Angle θₒ is the angular semi-aperture of the system, and n is the index of refraction of the material filling the space between the system and the substrate to be patterned.

To print smaller and smaller structures, current lithographic trends involve increasing the numerical aperture (NA). However, although the increased NA permits greater resolution, the depth of focus for the images projected into the light-sensitive material is reduced, leading to thinner mask layers. As the light-sensitive layer thickness decreases, the patterned light-sensitive layer becomes less effective as a mask for pattern etching, i.e., most of the (light-sensitive) mask layer is consumed during etching. Without a dramatic improvement in etch selectivity, single layer masks have become deficient in providing the necessary lithographic and etch characteristics suitable for high resolution lithography.

An additional shortcoming of single layer masks is the control of critical dimension (CD). Substrate reflections at ultraviolet (UV) and deep ultraviolet (DUV) wavelengths are known to cause standing waves in the light-sensitive layer due to thin film interference. This interference manifests as periodic variations in light intensity in the light-sensitive layer during exposure resulting in vertically spaced striations in the light-sensitive layer and loss of CD.

In order to counter the effects of standing waves in the light-sensitive layer as well as provide a thicker mask for subsequent pattern etch transfer, a bilayer or multilayer mask can be formed that incorporates a bottom anti-reflective coating (BARC). The BARC layer includes a thin absorbing film to reduce thin film interference; however, the BARC layer can still suffer from several limitations including poor thickness uniformity due in part to spin-on deposition techniques.

A hard mask may also be used to provide improved maintenance of critical dimensions. The hard mask may be a vapor deposited thin film provided under the light sensitive layer to provide better etch selectivity than the light sensitive layer alone. This etch selectivity of the hard mask material permits use of a thinner mask that allows greater resolution while also allowing a deeper etch process. The present inventors have recognized, however, that the use of conventional hard masks have limited etch selectivity and resilience to etch processes that will limit their use in future generation devices with even smaller structures.

### SUMMARY OF THE INVENTION

One aspect of the present invention is to reduce or eliminate any or all of the above-described problems.

Another object of the present invention is to provide a method of etching a layer to improve etch characteristics.

Yet another aspect of the present invention is to provide a method of etching a tunable etch resistant anti-reflective (TERA) coating.

According to yet another aspect, a method of preparing a structure on a substrate is described that includes forming a tunable etch resistant anti-reflective (TERA) coating on the substrate, the TERA coating comprising a structural formula R:C:H:X, wherein R is selected from the group including at least one of Si, Ge, B, Sn, Fe, Ti, and combinations thereof, and wherein X is not present or is selected from the group including one or more of O, N, S, and F. A layer of light-sensitive material is formed on the TERA coating. A pattern is formed in the layer of light-sensitive material, and the pattern is transferred to the thin film using an etch process including SF₆.

According to yet another aspect, a method of etching a TERA coating is described that includes disposing a substrate in a plasma processing system, the substrate having the TERA coating, wherein the TERA coating comprises a structural formula R:C:H:X, where R is selected from the group comprising at least one of Si, Ge, B, Sn, Fe, Ti, and combinations thereof, and where X is not present or is selected from the group comprising one or more of O, N, S, and F. A process gas is introduced having SF₆, a plasma is formed from the process gas, and the substrate is exposed to the plasma.

According to yet another aspect, a plasma processing system for etching a TERA coating on a substrate is described. The system includes a process chamber, a substrate holder coupled to the process chamber, and configured to support the substrate, wherein the substrate includes a TERA coating having a structural formula R:C:H:X, wherein R is selected from the group comprising at least one of Si, Ge, B, Sn, Fe, Ti, and combinations thereof, and wherein X is not present or is selected from the group comprising one or more of O, N, S, and F, a gas injection system coupled to the process chamber, and configured to introduce a process gas having SF₆, and a plasma source coupled to the process chamber, and configured to form a plasma from the process gas.

### BRIEF DESCRIPTION OF THE DRAWINGS

In the accompanying drawings, which form a part of the description herein, like reference numerals are employed to refer to like structure, wherein:

FIGS. 1A and 1B illustrate a film stack including a tunable etch resistant anti-reflective (TERA) coating;

FIGS. 2A and 2B illustrate another film stack including a TERA coating;

FIG. 3 shows a method for etching a TERA coating according to an embodiment of the invention;

FIG. 4 shows a simplified schematic diagram of a plasma processing system according to an embodiment of the present invention;

FIG. 5 shows a schematic diagram of a plasma processing system according to another embodiment of the present invention;

FIG. 6 shows a schematic diagram of a plasma processing system according to another embodiment of the present invention;

FIG. 7 shows a schematic diagram of a plasma processing system according to another embodiment of the present invention; and

FIG. 8 shows a schematic diagram of a plasma processing system according to another embodiment of the present invention.

### DETAILED DESCRIPTION OF EXEMPLARY EMBODIMENTS

As described earlier, the use of a hard mask has been adopted to complement the lithographic structure, and can be utilized in applications where the specifications for critical dimensions are stringent. One variety of hard masks can be broadly classified as having a structural formula R:C:H:X, wherein R is selected from the group comprising at least one of Si, Ge, B, Sn, Fe, Ti, and combinations thereof, and wherein X is not present or is selected from the group comprising one or more of O, N, S, and F. Such hard masks can be referred to as a tunable etch resistant anti-reflective (TERA) coating. These TERA coatings can be produced having a tunable index of refraction and extinction coefficient which can be optionally graded along the film thickness to match the optical properties of the substrate with the imaging light-sensitive layer. U.S. Pat. No. 6,316,167, assigned to International Business Machines Corporation, which is incorporated herein by reference in its entirety, describes such. As described in this patent, TERA films are used in lithographic structures for front end of line (FEOL) operations, such as gate formation, where control of the critical dimension is very important. In these applications, TERA coatings provide substantial improvement to the lithographic structure for forming gate devices at the 65 nm device node and smaller.

As noted above, in material processing methodologies, pattern etching utilizing such a lithographic structure generally includes the application of a thin layer of light-sensitive material, such as photoresist, to an upper surface of a substrate, that is subsequently patterned in order to provide a mask for transferring this pattern to the underlying hard mask during etching. The present inventors have discovered, however, that conventional hard mask films such as TERA coatings can be damaged during processing steps using conventional etch chemistries. For example, a CHF₃-based etch chemistry, such as CHF₃/N₂ or CHF₃/N₂/O₂, can lead to poor etch selectivity between the TERA coating and underlying layers, poor sidewall profile control, and excessive deposition. Additionally, for example, Cl₂-based etch chemistries, such as Cl₂, Cl₂/CHF₃, Cl₂/O₂, Cl₂/C₄F₈ or Cl₂/CH₂F₂, can lead to poor etch selectivity to photoresist as well as underlying layers, and profile undercutting. The present inventors have discovered that an alternative etch chemistry can lead to improved etch characteristics.

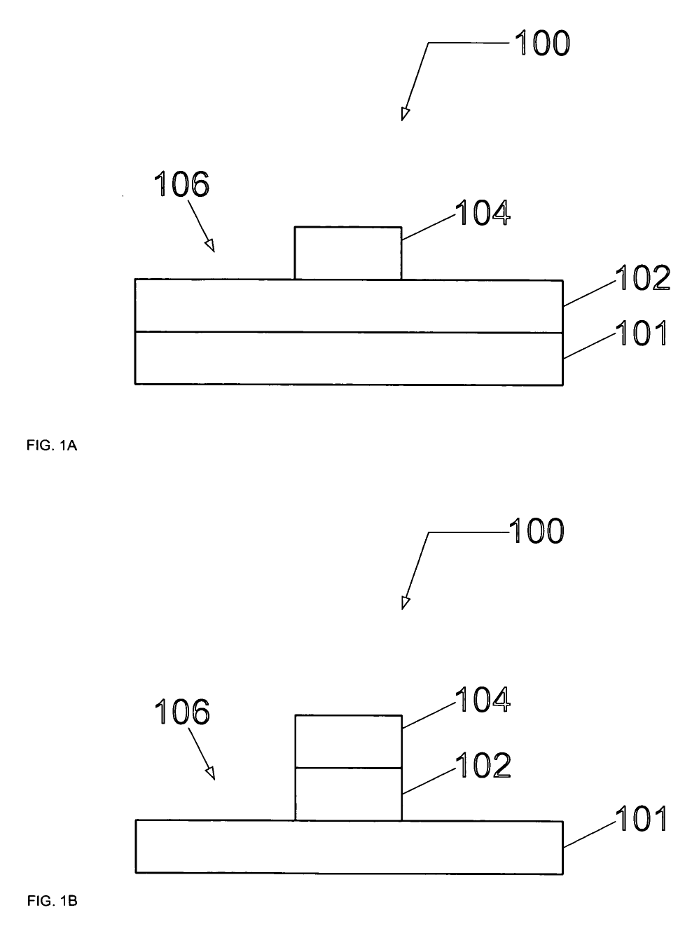

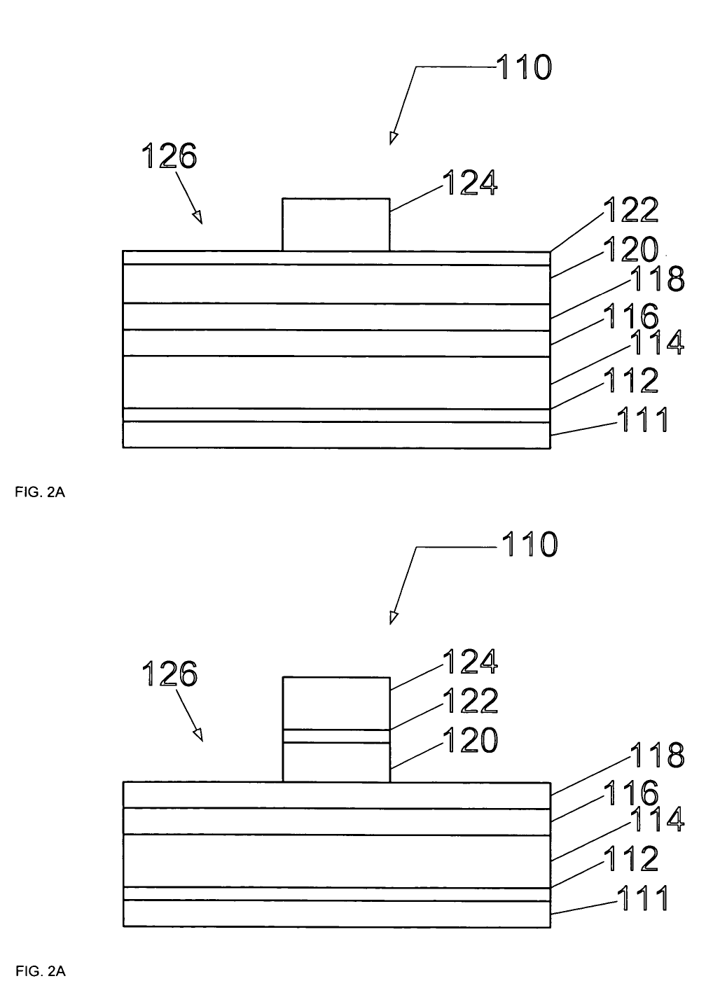

FIGS. 1A and 1B show a conventional etching process for a hard mask layer, such as a TERA coating, wherein the invention can be applied. As shown in FIG. 1A, a film stack 100 is formed having a substrate 101, a thin film 102, such as a TERA coating, formed on the substrate 101, and a layer of light-sensitive material 104 formed on the thin film 102. A pattern 106 can be formed in the layer of light-sensitive material 104 using conventional lithographic techniques. As seen in FIG. 1B, the pattern 106 in the light-sensitive layer 104 is transferred to the thin film 102 using an etch step. Additionally, for example, the invention can be applied to a gate stack, such as film stack 110 shown in FIGS. 2A and 2B. Therein, the film stack 110 is formed having a substrate 111, a gate oxide layer 112 (such as a silicon oxide layer, or high dielectric constant oxide layer), a gate polysilicon layer 114, a nitride layer 116 (such as a silicon nitride layer), an oxide layer 118, a hard mask 120 (such as a TERA coating), a cap layer 122 (such as a layer containing Si, C, O, H), and a layer of light-sensitive material 124. A pattern 126 can formed in the layer of light-sensitive material 124 using conventional lithographic techniques. As seen in FIG. 2B, the pattern 126 in the light-sensitive layer 124 is transferred to the cap layer 122 and the hard mask 120 using an etch step.

In one embodiment of the invention, a process gas including SF₆ is introduced to a plasma processing system in order to form a fluorinated plasma. Thereafter, a substrate having a patterned layer of light-sensitive material, such as photoresist, is exposed to the plasma in order to transfer the pattern into an underlying TERA coating. The present inventors have discovered that etching the TERA coating using a SF₆-based etch chemistry improves the etch characteristics of the hard mask.

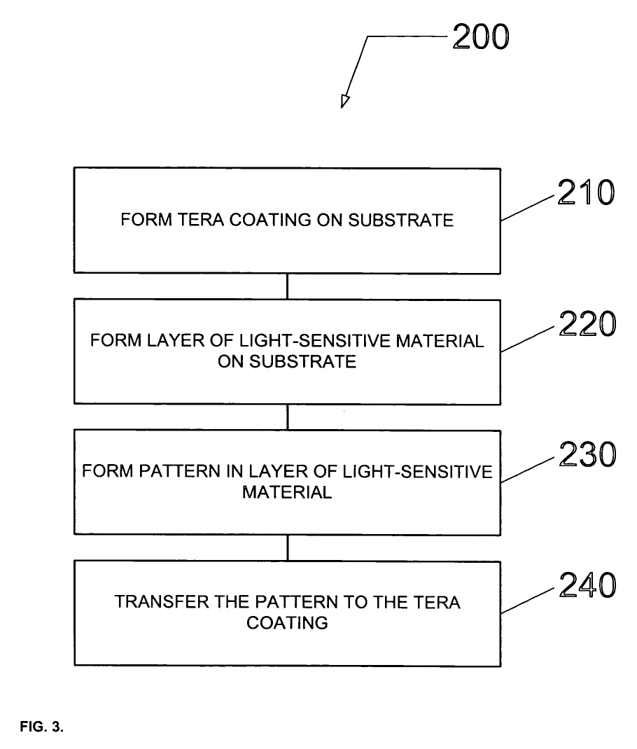

In another embodiment, referring now to FIG. 3, a method of etching a TERA coating in a film stack is described. The method is illustrated as a flow chart 200 beginning in 210 with forming a TERA coating on a substrate as in FIGS. 1A and 1B, or 2A and 2B. The TERA coating can be formed using vapor deposition techniques, such as chemical vapor deposition (CVD), or plasma enhanced chemical vapor deposition (PECVD).

The TERA coating includes a structural formula R:C:H:X, wherein R is selected from the group comprising at least one of Si, Ge, B, Sn, Fe, Ti, and combinations thereof, and wherein X is not present or is selected from the group comprising one or more of O, N, S, and F. The TERA coating can be fabricated to demonstrate an optical range for an index of refraction of approximately 1.40<n<2.60, and for an extinction coefficient of approximately 0.01<k<0.78. Alternately, at least one of the index of refraction and the extinction coefficient can be graded (or varied) along a thickness of the TERA coating. Additional details are provided in U.S. Pat. No. 6,316,167. Furthermore, the TERA coating can be formed using PECVD, as described in greater detail in pending U.S. patent application Ser. No. 10/644,958, entitled “Method and apparatus for depositing materials with tunable optical properties and etching characteristics”, filed on Aug. 21, 2003, the entire contents of which are incorporated herein by reference in their entirety. The optical properties of the TERA coating, such as the index of refraction, can be selected so as to substantially match the optical properties of the underlying layer, or layers. For example, underlying layers such as non-porous dielectric films can require achieving an index of refraction in the range of 1.4<n<2.6, and underlying layers such as porous dielectric films can require achieving an index of refraction in the range of 1.2<n<2.6.

In 220, a layer of light-sensitive material is formed on the substrate. The layer of light-sensitive material can include a photoresist. For example, the layer (or layers) of light-sensitive material can be formed using a track system. The track system can be configured for processing 248 nm resists, 193 nm resists, 157 nm resists, EUV resists, (top/bottom) anti-reflective coatings (TARC/BARC), and top coats. For example, the track system can include a Clean Track ACT® 8, or Clean Track ACT® 12 resist coating and developing system commercially available from Tokyo Electron Limited (TEL). Other systems and methods for forming a photoresist film on a substrate are well known to those skilled in the art of spin-on resist technology.

Once the layer of light-sensitive material is formed on the substrate, it can be patterned with a pattern using micro-lithography in 230, followed by the removal of the irradiated regions of the light-sensitive material (as in the case of positive photoresist), or non-irradiated regions (as in the case of negative resist) using a developing solvent. The micro-lithography system can include any suitable conventional stepping lithographic system, or scanning lithographic system.

In 240, the pattern formed in the layer of light-sensitive material is transferred to the underlying TERA coating using a dry etch process. The dry etch process includes a SF₆-based etch chemistry. Alternately, the etch chemistry can further include an oxygen-containing gas, such as O₂, CO, or CO₂. Alternately, the etch chemistry can further include a nitrogen-containing gas, such as N₂ or NH₃. Alternately, the etch chemistry can further include an inert gas, such as a Noble gas (i.e., helium, neon, argon, xenon, krypton, radon). Alternately, the etch chemistry can further include another halogen-containing gas, such as Cl₂, HBr, CHF₃, or CH₂F₂. Alternately, the etch chemistry can further include a fluorocarbon gas, such as gas having the structure CₓF_{y} (e.g., CF₄, C₄F₈, C₄F₆, C₃F₆, C₅F₈, etc.).

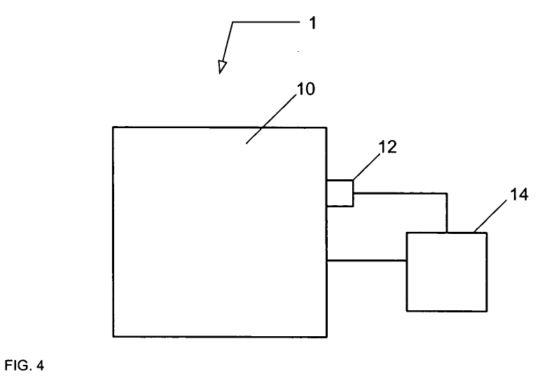

The etching process of the present invention can be performed in a plasma processing system. For example, FIG. 4 presents an exemplary plasma processing system 1 that may be used to implement a process of the present invention. As seen in this Figure, the plasma processing system 1 includes a plasma processing chamber 10, a diagnostic system 12 coupled to the plasma processing chamber 10, and a controller 14 coupled to the diagnostic system 12 and the plasma processing chamber 10. The controller 14 is configured to execute a process recipe including an etching process. Additionally, the controller 14 is configured to receive at least one endpoint signal from the diagnostic system 12 and to post-process the at least one endpoint signal in order to accurately determine an endpoint for the process. In the illustrated embodiment, plasma processing system 1, depicted in FIG. 4, utilizes a plasma for material processing. The plasma processing system 1 can include an etch chamber.

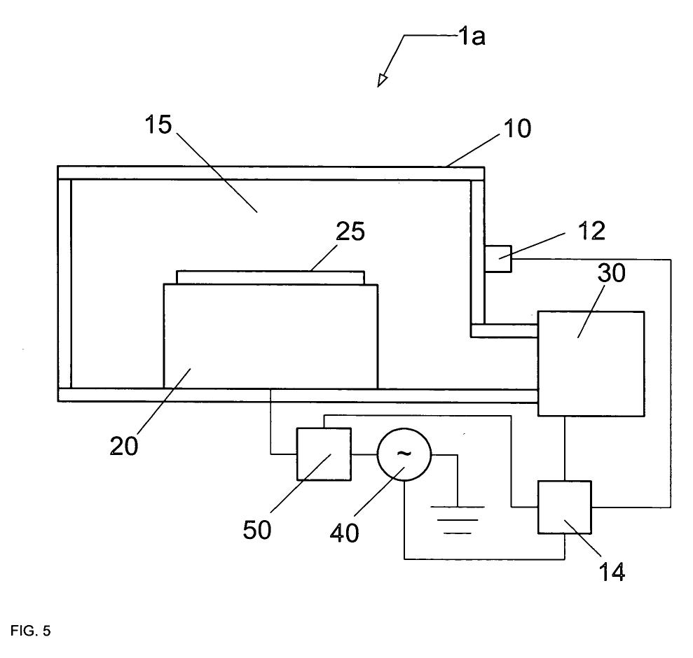

According to the embodiment depicted in FIG. 5, a plasma processing system 1a used in accordance with the present invention can include the plasma processing chamber 10, substrate holder 20, upon which a substrate 25 to be processed is affixed, and vacuum pumping system 30. The substrate 25 can be, for example, a semiconductor substrate, a wafer or a liquid crystal display. The plasma processing chamber 10 can be, for example, configured to facilitate the generation of plasma in a processing region 15 adjacent to a surface of the substrate 25. An ionizable gas or mixture of gases is introduced via a gas injection system (such as a gas injection pipe, or gas injection showerhead) and the process pressure is adjusted. For example, a control mechanism (not shown) can be used to throttle the vacuum pumping system 30. Plasma can be utilized to create materials specific to a pre-determined materials process and/or to aid the removal of material from the exposed surfaces of the substrate 25. The plasma processing system 1a can be configured to process 200 mm substrates, 300 mm substrates, or larger.

The substrate 25 can be, for example, affixed to the substrate holder 20 via an electrostatic clamping system. Furthermore, the substrate holder 20 can, for example, further include a cooling system including a re-circulating coolant flow that receives heat from the substrate holder 20 and transfers heat to a heat exchanger system (not shown), or when heating, transfers heat from the heat exchanger system. Moreover, gas can, for example, be delivered to the back-side of the substrate 25 via a backside gas system to improve the gas-gap thermal conductance between the substrate 25 and the substrate holder 20. Such a system can be utilized when temperature control of the substrate 25 is required at elevated or reduced temperatures. For example, the backside gas system can include a two-zone gas distribution system, wherein the helium gas gap pressure can be independently varied between the center and the edge of the substrate 25. In other embodiments, heating/cooling elements, such as resistive heating elements, or thermo-electric heaters/coolers can be included in the substrate holder 20, as well as the chamber wall of the plasma processing chamber 10 and any other component within the plasma processing system 1a.

In the embodiment shown in FIG. 5, the substrate holder 20 can include an electrode through which RF power is coupled to the processing plasma in the process space 15. For example, the substrate holder 20 can be electrically biased at a RF voltage via the transmission of RF power from a RF generator 40 through an impedance match network 50 to the substrate holder 20. The RF bias can serve to heat electrons to form and maintain a plasma. In this configuration, the system can operate as a reactive ion etch (RIE) reactor, wherein the chamber and an upper gas injection electrode serve as ground surfaces. A typical frequency for the RF bias can range from 0.1 MHz to 100 MHz. RF systems for plasma processing are well known to those skilled in the art.

Alternately, RF power is applied to the substrate holder electrode at multiple frequencies. Furthermore, the impedance match network 50 serves to improve the transfer of RF power to plasma in the plasma processing chamber 10 by reducing the reflected power. Match network topologies (e.g., L-type, π-type, T-type, etc.) and automatic control methods are well known to those skilled in the art.

The vacuum pump system 30 can, for example, include a turbo-molecular vacuum pump (TMP) capable of a pumping speed up to 5000 liters per second (and greater) and a gate valve for throttling the chamber pressure. In conventional plasma processing devices utilized for dry plasma etch, a 1000 to 3000 liter per second TMP is generally employed. TMPs are useful for low pressure processing, typically less than 50 mTorr. For high pressure processing (i.e., greater than 100 mTorr), a mechanical booster pump and dry roughing pump can be used. Furthermore, a device for monitoring chamber pressure (not shown) can be coupled to the plasma processing chamber 10. The pressure measuring device can be, for example, a Type 628B Baratron absolute capacitance manometer commercially available from MKS Instruments, Inc. (Andover, Mass.).

The controller 14 includes a microprocessor, a memory, and a digital I/O port capable of generating control voltages sufficient to communicate and activate inputs to the plasma processing system 1a as well as monitor outputs from the plasma processing system 1a. Moreover, the controller 14 can be coupled to and can exchange information with the RF generator 40, the impedance match network 50, the gas injection system (not shown), the vacuum pump system 30, the diagnostic system 12, as well as the backside gas delivery system (not shown), the substrate/substrate holder temperature measurement system (not shown), and/or the electrostatic clamping system (not shown). For example, a program stored in the memory can be utilized to activate the inputs to the aforementioned components of the plasma processing system 1a according to a process recipe in order to perform an etching process. One example of the controller 14 is a DELL PRECISION WORKSTATION 610™, available from Dell Corporation, Austin, Tex.

The controller 14 can be locally located relative to the plasma processing system 1a, or it can be remotely located relative to the plasma processing system 1a. For example, the controller 14 can exchange data with the plasma processing system 1a using at least one of a direct connection, an intranet, and the Internet. The controller 14 can be coupled to an intranet at, for example, a customer site (i.e., a device maker, etc.), or it can be coupled to an intranet at, for example, a vendor site (i.e., an equipment manufacturer). Additionally, for example, the controller 14 can be coupled to the Internet. Furthermore, another computer (i.e., controller, server, etc.) can, for example, access the controller 14 to exchange data via at least one of a direct connection, an intranet, and the Internet. Also, data may be transferred via a wired or a wireless connection, as would be appreciated by those skilled in the art.

The diagnostic system 12 can include an optical diagnostic subsystem (not shown). The optical diagnostic subsystem can include a detector such as a (silicon) photodiode or a photomultiplier tube (PMT) for measuring the light intensity emitted from the plasma. The diagnostic system 12 can further include an optical filter such as a narrow-band interference filter. In an alternate embodiment, the diagnostic system 12 can include at least one of a line CCD (charge coupled device), a CID (charge injection device) array, and a light dispersing device such as a grating or a prism. Additionally, the diagnostic system 12 can include a monochromator (e.g., grating/detector system) for measuring light at a given wavelength, or a spectrometer (e.g., with a rotating grating) for measuring the light spectrum such as, for example, the device described in U.S. Pat. No. 5,888,337, the contents of which are incorporated herein by reference in their entirety.

The diagnostic system 12 can include a high resolution Optical Emission Spectroscopy (OES) sensor such as from Peak Sensor Systems, or Verity Instruments, Inc. Such an OES sensor has a broad spectrum that spans the ultraviolet (UV), visible (VIS), and near infrared (NIR) light spectrums. The resolution is approximately 1.4 Angstroms, that is, the sensor is capable of collecting 5550 wavelengths from 240 to 1000 nm. For example, the OES sensor can be equipped with high sensitivity miniature fiber optic UV-VIS-NIR spectrometers which are, in turn, integrated with 2048 pixel linear CCD arrays.

The spectrometers receive light transmitted through single and bundled optical fibers, where the light output from the optical fibers is dispersed across the line CCD array using a fixed grating. Similar to the configuration described above, light emitting through an optical vacuum window is focused onto the input end of the optical fibers via a convex spherical lens. Three spectrometers, each specifically tuned for a given spectral range (UV, VIS and NIR), form a sensor for a process chamber. Each spectrometer includes an independent A/D converter. And lastly, depending upon the sensor utilization, a full emission spectrum can be recorded every 0.1 to 1.0 seconds.

Furthermore, the diagnostic system 12 can include a system for performing optical digital profilometry, such as the system offered by Timbre Technologies, Inc. (2953 Bunker Hill Lane, Suite 301, Santa Clara, Calif. 95054).

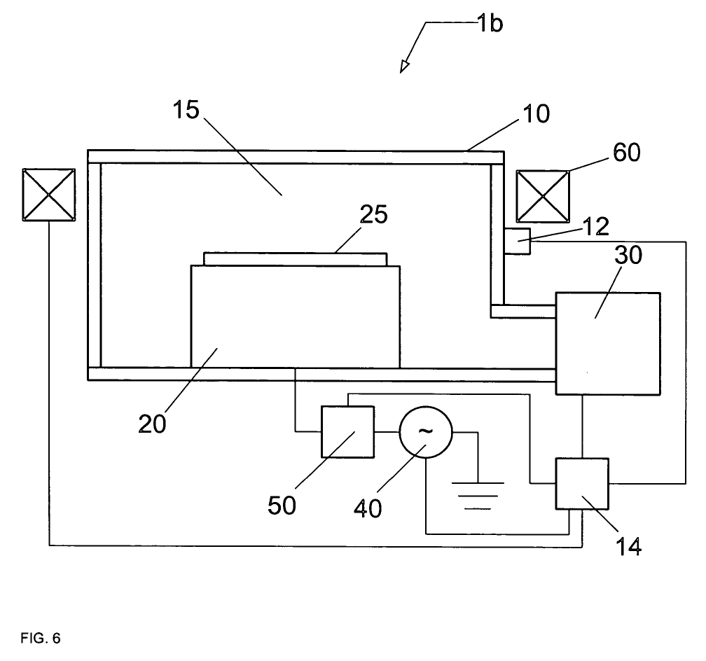

In the embodiment shown in FIG. 6, a plasma processing system 1b that may be used to implement the present invention can, for example, be similar to the embodiment of FIG. 4 or FIG. 5 and can further include either a stationary, or mechanically or electrically rotating magnetic field system 60, in order to potentially increase plasma density and/or improve plasma processing uniformity, in addition to those components described with reference to FIG. 4 and FIG. 5. Moreover, the controller 14 can be coupled to the magnetic field system 60 in order to regulate the speed of rotation and field strength. The design and implementation of a rotating magnetic field is well known to those skilled in the art.

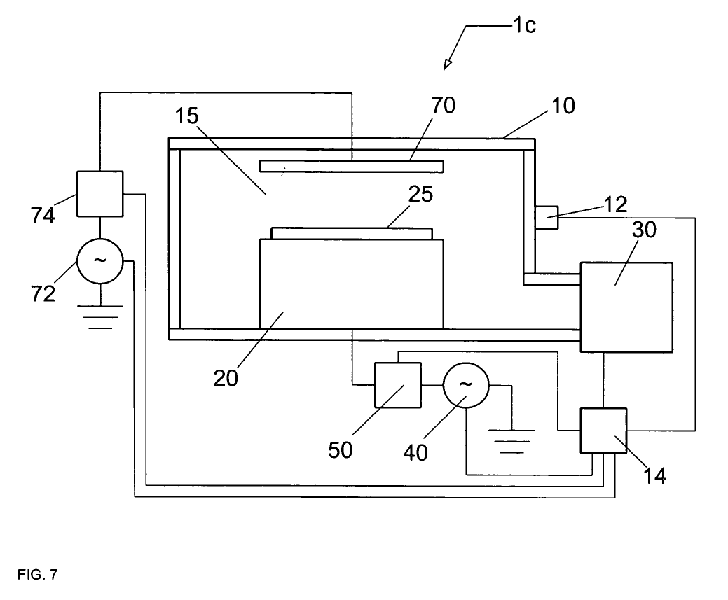

In the embodiment shown in FIG. 7, a plasma processing system 1c that may be used to implement the present invention can, for example, be similar to the embodiment of FIG. 4 or FIG. 5, and can further include an upper electrode 70 to which RF power can be coupled from an RF generator 72 through an impedance match network 74. A typical frequency for the application of RF power to the upper electrode 70 can range from 0.1 MHz to 200 MHz. Additionally, a typical frequency for the application of power to the lower electrode can range from 0.1 MHz to 100 MHz. Moreover, the controller 14 is coupled to the RF generator 72 and the impedance match network 74 in order to control the application of RF power to the upper electrode 70. The design and implementation of an upper electrode is well known to those skilled in the art.

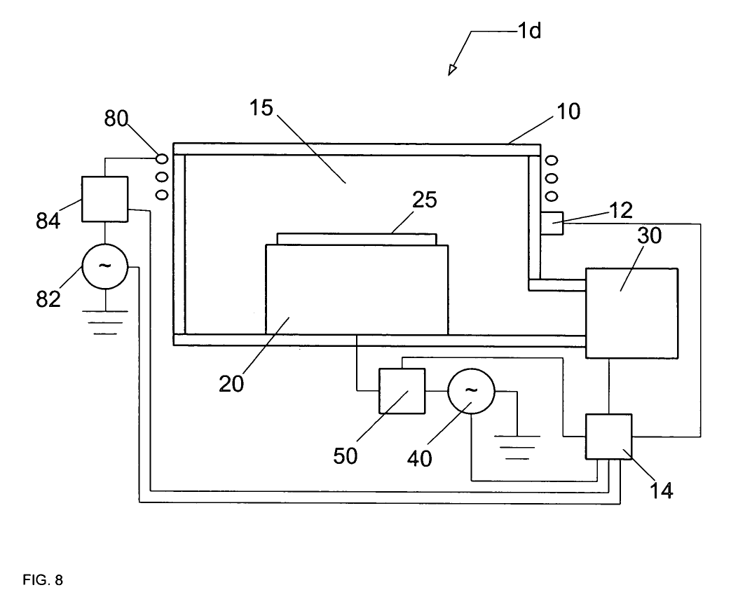

In the embodiment shown in FIG. 8, a plasma processing system 1d that may be used to implement the present invention can, for example, be similar to the embodiments of FIGS. 4 and 5, and can further include an inductive coil 80 to which RF power is coupled via an RF generator 82 through an impedance match network 84. RF power is inductively coupled from the inductive coil 80 through a dielectric window (not shown) to the plasma processing region 15. A typical frequency for the application of RF power to the inductive coil 80 can range from 10 MHz to 100 MHz. Similarly, a typical frequency for the application of power to the chuck electrode can range from 0.1 MHz to 100 MHz. In addition, a slotted Faraday shield (not shown) can be employed to reduce capacitive coupling between the inductive coil 80 and plasma. Moreover, the controller 14 is coupled to the RF generator 82 and the impedance match network 84 in order to control the application of power to the inductive coil 80. In an alternate embodiment, the inductive coil 80 can be a “spiral” coil or “pancake” coil in communication with the plasma processing region 15 from above as in a transformer coupled plasma (TCP) reactor. The design and implementation of an inductively coupled plasma (ICP) source, or transformer coupled plasma (TCP) source, is well known to those skilled in the art.

Alternately, the plasma can be formed using electron cyclotron resonance (ECR). In yet another embodiment, the plasma can be formed from the launching of a Helicon wave. In yet another embodiment, the plasma can be formed from a propagating surface wave. Each plasma source described above is well known to those skilled in the art.

In one example, an etch process can be performed in a plasma processing system, such as the system described in FIG. 7, wherein the process parameter space can comprise a chamber pressure of about 5 to about 200 mTorr, a SF₆ process gas flow rate ranging from about 5 to about 1000 sccm, an upper electrode (e.g., element 70 in FIG. 7) RF bias ranging from about 50 to about 500 W, a lower electrode (e.g., element 20 in FIG. 7) RF bias ranging from about 10 to about 500 W, the upper electrode bias frequency can range from about 0.1 MHz to about 200 MHz, e.g., 60 MHz, and the lower electrode bias frequency can range from about 0.1 MHz to about 100 MHz, e.g., 2 MHz.

In another example, Table I presents the critical dimensions of a feature etched in a TERA coating utilizing the following exemplary process recipe: Chamber pressure=20 mTorr; Upper electrode RF power=100 W; Lower electrode RF power=80 W; Process gas flow rate SF₆=100 sccm; a 140 mm electrode spacing between the lower surface of electrode 70 (see FIG. 7) and the upper surface of substrate 25 on substrate holder 20; Lower electrode temperature (e.g., substrate holder 20 in FIG. 7)=30° C.; Upper electrode temperature (e.g., electrode 70 in FIG. 7)=80° C.; Chamber wall temperature=60° C.; Backside helium pressure Center/Edge=3/3 Torr; and an etch time of 17 seconds.

TABLE 1

| SF₆ | ISOLATED | NESTED |
|---|---|---|
| TOP CD | 45 nm | 49 nm |
| BOTTOM CD | 46 nm | 50 nm |

The data of Table 1 is reported for both isolated features (i.e., broad spacing of features), and nested features (i.e., close spacing of features). The data demonstrates the success of the process in maintaining the critical dimension (CD).

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A method of preparing a structure on a substrate comprising:
forming a tunable etch resistant anti-reflective (TERA) coating on said substrate, said TERA coating comprises a structure defined by the formula R:C:H:X, wherein R is selected from the group comprising at least one of Si, Ge, B, Sn, Fe, Ti, and combinations thereof, and wherein X is not present or is selected from the group comprising one or more of O, N, S, and F;
forming a layer of light-sensitive material on said TERA coating;
forming a pattern in said layer of light-sensitive material; and
transferring said pattern to said TERA coating using an etch process including at least SF₆.

2. The method of claim 1, wherein said etch process further comprises an oxygen-containing gas.

3. The method of claim 2, wherein said etch process further comprises at least one of O₂, CO, and CO₂.

4. The method of claim 1, wherein said etch process further comprises an inert gas.

5. The method of claim 4, wherein said etch process further comprises a Noble gas.

6. The method of claim 1, wherein said etch process further comprises a halogen-containing gas.

7. The method of claim 6, wherein said etch process further comprises using at least one of Cl₂, HBr, CHF₃, and CH₂F₂.

8. The method of claim 1, wherein said d etch process further comprises a fluorocarbon-containing gas.

9. The method of claim 8, wherein said etch process further comprises a gas having a structure of CₓF_{y}, where x, y are integers greater than or equal to unity.

10. The method of claim 1, wherein said etch process comprises setting at least one of a pressure, a temperature, and a radio frequency (RF) power.

11. A method of etching a TERA coating comprising:
disposing a substrate in a plasma processing system, said substrate having said TERA coating, wherein said TERA coating comprises a structure defined by the formula R:C:H:X, where R is selected from the group comprising at least one of Si, Ge, B, Sn, Fe, Ti, and combinations thereof, and where X is not present or is selected from the group comprising one or more of O, N, S, and F;
introducing a process gas including at least SF₆;
forming a plasma from said process gas; and
exposing said substrate to said plasma.

12. The method of claim 11, wherein said process gas further comprises an oxygen-containing gas.

13. The method of claim 12, wherein said process gas further comprises at least one of O₂, CO, and CO₂.

14. The method of claim 11, wherein said d process gas further comprises an inert gas.

15. The method of claim 14, wherein said process gas further comprises a Noble gas.

16. The method of claim 11, wherein said process gas further comprises a halogen-containing gas.

17. The method of claim 16, wherein said process gas further comprises at least one of Cl₂, HBr, CHF₃, and CH₂F₂.

18. The method of claim 11, wherein said process gas further comprises a fluorocarbon-containing gas.

19. The method of claim 18, wherein said process gas further comprises a gas having a structure of CₓF_{y}, where x, y are integers greater than or equal to unity.

20. The method of claim 11, wherein introducing said process gas further comprises setting at least one of a pressure, a temperature, and a radio frequency (RF) power.

21. A plasma processing system for etching a TERA coating on a substrate comprising:
a process chamber;
a substrate holder disposed within said process chamber, and being configured to support said substrate, wherein said substrate includes a TERA coating with a structure defined by the formula R:C:H:X, wherein R is selected from the group comprising at least one of Si, Ge, B, Sn, Fe, Ti, and combinations thereof, and wherein X is not present or is selected from the group comprising one or more of O, N, S, and F;
a gas injection system coupled to said process chamber, and configured to introduce a process gas including at least SF₆; and
a plasma source coupled to said process chamber, and configured to form a plasma from said process gas.

22. The system of claim 21, wherein said process gas further comprises an oxygen-containing gas.

23. The system of claim 22, wherein said process gas further comprises at least one of O₂, CO, and CO₂.

24. The system of claim 21, wherein said process gas further comprises an inert gas.

25. The system of claim 24, wherein said process gas further comprises a Noble gas.

26. The system of claim 21, wherein said process gas further comprises a halogen-containing gas.

27. The system of claim 26, wherein said process gas further comprises at least one of Cl₂, HBr, CHF₃, and CH₂F₂.

28. The system of claim 21, wherein said process gas further comprises a fluorocarbon-containing gas.

29. The system of claim 28, wherein said process gas further comprises a gas having a structure of CₓF_{y}, where x, y are integers greater than or equal to unity.

30. The system of claim 21, further comprising:
a controller coupled to said gas injection system, and configured to control a flow rate of said process gas.
